(19) United States
(12) Patent Application Publication
(10) Pub. No.: US 2023/0357609 A1
(43) Pub. Date: Nov. 9, 2023

(54) UV-CURABLE ADHESIVE COMPOSITION FOR DIGITAL PRINTING

(71) Applicant: NEOS S.r.l., Fiorano Modenese (MO) (IT)

(72) Inventor: Vincenzo Palumbo, Fiorano Modenese (MO) (IT)

(73) Assignee: NEOS S.r.l., Fiorano Modenese (MO) (IT)

(21) Appl. No.: 18/029,018

(22) PCT Filed: Sep. 27, 2021
(86) PCT No.: PCT/IB2021/058798

§ 371 Date: Mar. 28, 2023

(30) Foreign Application Priority Data
Sep. 28, 2020 (IT) 102020000022819

(51) Int. Cl. C09J 133/08; C09J 11/06

(52) U.S. Cl. CPC C09J 133/08; C09J 11/06; C09J 2301/416; C09J 2301/50; C09J 2203/306

(57) ABSTRACT

An adhesive composition polymerizable by applying ultraviolet radiation comprising an acrylate resin and a photoinitiator, said acrylate resin comprising at least one acrylate monomer, and optionally, an acrylate oligomer; a process for the application of a covering layer to a polymeric product comprising the step of applying the afore-mentioned adhesive composition above an ink layer for digital printing, preferably a U.V. ink, deposited on a surface of said planar substrate to define a printing pattern, thereby providing an interface layer between said planar substrate and said covering layer of subsequent application.

### APPLICATION FIELD

The present invention relates to an adhesive composition polymerizable by applying ultraviolet (UV) radiation.

In particular, such adhesive composition is useful to make an interface layer between a planar substrate of polymeric material and a covering layer of transparent polymeric material and to protect a printing pattern, the latter made with an ink for digital printing.

Therefore, the present invention relates to a process for the application of a covering layer to a polymeric product, i.e., a polyvinyl chloride (PVC) sheet or panel. The covering layer is particularly provided for protection of graphics printed with an ink for digital printing on the polymeric product.

The invention also relates to a thus made multilayer product.

The invention may find useful application in various technological fields where digital printing decoration of a polymeric support is required.

For example, it can be usefully used in the realization of multilayer sheets with a digital printing decoration. Such sheets are typically used for surface decorative covering.

In the realization of vinyl floors, for example, a decorative PVC sheet that reproduces a wooden, stone or metal surface is coupled by calendering or pressing on a support base that defines the body of the sheet.

Similar decorative applications of polymeric sheets can be envisaged for example on PVC window frames or skirting boards.

### BACKGROUND ART

The thermoplastic sheets of the above-mentioned type are made from a substrate, typically white PVC, on which a decorative pattern is printed. The substrate is then covered by a further transparent PVC layer, with protection function of the printed pattern.

The above-described configuration is schematically represented in FIG. 1, which illustrates a thermoplastic sheet 10′ made according to a method of the background art.

As stated above, the thermoplastic sheet 10′ shows a PVC substrate 11, above which the ink layer 12 is deposited defining the printing decoration. The next transparent PVC covering layer 14 is applied by hot rolling, at temperatures indicatively between 150° C. and 170° C., on the ink layer 12 and guarantees its durability over time, preventing abrasion phenomena.

The production processes known to date are however limited by the type of ink used in the realization of the printed decoration. In particular, these processes can be effectively used only where printing is carried out with certain solvent-borne inks.

On the other hand, it has been found that other digital printing inks, such as U.V. inks, form a barrier to adhesion between the two PVC layers. Due to this barrier effect, the rolling step does not guarantee a stable and lasting application of the transparent coating layer, and the resulting quality of the product is insufficient for its commercial distribution.

The afore-mentioned barrier effect has been found with the main inks used in the digital printing excluding certain solvent-borne inks.

On the other hand, however, solvent-borne inks generally involve risks to the health of operators due to their known carcinogenic properties and/or require special precautions about their handling and storage due to the high risk of flammability.

Further, in addition to involving a great energy expenditure during the hot rolling step, the technologies known for producing laminates with solvent-borne inks require a drying step with printing ink solvent evaporation, making the known processes certainly impacting from the point of view of environmental sustainability.

For the above-mentioned reasons, to date, for the operator who does not want to use solvent-borne inks, protective coating layer-equipped thermoplastic sheets are mostly obtained with analogical printing. This results in a substantial limitation in the industrial field, where digital printing is progressively becoming established as it combines the speed of processing with absolute flexibility in the choice of images and/or printing patterns.

The technical problem underlying the present invention is therefore that of providing a technology allowing the application of a covering layer to a polymeric product, in particular to a sheet or panel, extending the compatibility of background art processes to other types of ink, suitable for digital printing.

### SUMMARY OF THE INVENTION

The afore-mentioned technical problem is solved by an adhesive composition polymerizable by applying ultraviolet (U.V.) radiation comprising an acrylate resin, in turn comprising at least one acrylate monomer, and a photoinitiator, wherein said at least one acrylate monomer is selected from an alkyl acrylate, an alkyl methacrylate, a diol diacrylate, a diol dimethacrylate, a polyol diacrylate, a polyol dimethacrylate, a polyol triacrylate, a polyol trimethacrylate, or any combination thereof.

Preferably, said at least one acrylate monomer is an alkyl acrylate or an alkyl methacrylate.

More preferably, when it is an alkyl acrylate, said acrylate monomer may be selected from octyl decyl acrylate, tetrahydrofurfuryl acrylate, isobornyl acrylate, ethyl acrylate, n-propyl acrylate, or isopropyl acrylate.

According to an alternative embodiment, when it is an alkyl acrylate, said acrylate monomer may comprise an ethoxylated and/or propoxylated alkyl chain.

Alternatively, said acrylate monomer may be a diol diacrylate, a diol dimethacrylate, a polyol diacrylate, a polyol triacrylate, a polyol dimethacrylate, or a polyol trimethacrylate.

More preferably, the acrylate monomer is a diol diacrylate.

Even more preferably, the acrylate monomer may be selected from 1,6-hexanediol diacrylate, 3-methyl-1,5-pentanediyl acrylate, or any mixture thereof.

Equally preferred, the acrylate monomer may be a polyol triacrylate; even more preferably, the acrylate monomer may be selected from glycerol propoxy triacrylate, trimethylolpropane ethoxylate triacrylate, or trimethylolpropane triacrylate.

According to an alternative embodiment, the acrylate monomer is a polyol diacrylate; preferably, the acrylate monomer may be tri(propylene glycol) diacrylate.

According to a further alternative embodiment, the acrylate monomer may be a polyol dimethacrylate; preferably, the acrylate monomer may be tri(ethylene glycol) dimethacrylate.

In particular, the above acrylate monomer may be a mono- or polyfunctional oligomer.

Even more in particular, in the composition according to the invention, the acrylate monomer may contain aliphatic or aromatic-type carbon chains; for example, the acrylate monomer may be an alkyl acrylate, wherein the alkyl chain, deriving from the alcohol that reacted with the acrylic acid, includes an aryl-type substituent.

Preferably, the acrylate monomer is present in an amount less than or equal to 98% by weight based on the total weight of the adhesive composition.

According to a different embodiment, the acrylate resin of the adhesive composition according to the invention may comprise also a polyacrylate.

In particular, according to the present invention, the term “polyacrylate” means a polymer or copolymer obtained by polymerization of salts or esters of acrylic acid or methacrylic acid.

According to a preferred embodiment thereof, the acrylate resin of the adhesive composition according to the invention may comprise also at least one acrylate oligomer.

According to a particular embodiment, the acrylate resin of the adhesive composition according to the invention may comprise an acrylate oligomer or a combination of several acrylate oligomers.

Preferably, the acrylate resin of the adhesive composition according to the invention comprises at least one acrylate oligomer.

More preferably, in the composition according to the invention, such at least one acrylate oligomer is selected from polyurethane acrylate, epoxy acrylate, acryl acrylate, polyether acrylate, polyester acrylate, vinyl acrylate, or any combination thereof.

In particular, the above at least one acrylate oligomer may be a mono- or polyfunctional oligomer.

For example, the at least one acrylate oligomer may be a polyether acrylate wherein on the alkyl chain, deriving from the polyol which reacted with the acrylic acid, an amine substituent is present, i.e., the oligomer is an amine-modified polyether acrylate.

In particular, in the composition according to the invention, such acrylate oligomer may contain aliphatic or aromatic-type carbon chains.

More preferably, in the composition according to the invention the at least one acrylate oligomer may be selected from bisphenol A epoxy diacrylate, amine-modified polyether acrylate, or aliphatic urethane diacrylate.

According to a particular embodiment, in the composition according to the invention said photoinitiator is a Norrish type I photoinitiator or a Norrish type II photoinitiator.

Preferably, in the composition according to the invention such photoinitiator may be a compound belonging to the family of acyl phosphines or a compound belonging to the family of thioxanthones.

More preferably, such photoinitiator is a compound belonging to the family of acyl phosphines.

Even more preferably, the photoinitiator is selected from phenylbis(2,4,6-trimethylbenzoyl) phosphine oxide, diphenyl(2,4,6-trimethylbenzoyl)phosphine oxide, or any combination thereof.

Most preferably, the photoinitiator is phenylbis(2,4,6-trimethylbenzoyl)phosphine oxide.

Alternatively, such photoinitiator is a compound belonging to the family of thioxanthones.

More preferably, the photoinitiator is selected from 4-isopropylthioxanthone, 2-isopropylthioxanthone, or any combination thereof.

Most preferably, the photoinitiator is 2-isopropylthioxanthone.

Preferably, said at least one acrylate monomer is present in an amount between 9% and 98% by weight based on the total weight of the adhesive composition.

Specifically, the acrylate monomer may be present in an amount between 10% and 100% by weight based on the total weight of the adhesive composition.

More preferably, said at least one acrylate monomer is present in an amount between 15% and 97%, even more preferably between 20% and 80%, by weight based on the total weight of the adhesive composition.

Preferably, the photoinitiator is present in an amount between 2% and 8%, more preferably between 3% and 6%, by weight based on the total weight of the adhesive composition.

Preferably, said at least one acrylate oligomer may be present in an amount between 1% and 88.5%, more preferably between 15% and 75%, even more preferably between 40% and 60%, by weight based on the total weight of the adhesive composition.

Preferably, said adhesive composition may comprise a co-initiator.

More preferably, said co-initiator is a tertiary amine, even more preferably a tertiary alkylamine.

Most preferably, said co-initiator may be a tertiary acrylate amine.

Anyway, said co-initiator may be a primary or secondary acrylate amine also.

Alternatively, said co-initiator may be a tertiary aromatic amine.

Anyway, said co-initiator may be a primary or secondary aromatic amine, too.

According to a preferred embodiment, the present adhesive composition comprises a co-initiator in an amount between 2-12%, preferably 5%, by weight based on its total weight.

Preferably, the adhesive composition of the present invention may comprise a modifying additive, more preferably an organic type modifying additive.

Advantageously, said modifying additive has the function of modulating the reactivity of the different components of the adhesive composition, and it can affect the adhesion properties of the polymeric film formed by polymerization and solidification of the present adhesive composition.

Most preferably, said organic type modifying additive is a vinyl copolymer, more preferably a vinyl chloride copolymer.

Even more preferably, said organic type modifying additive is a vinyl chloride and vinyl acetate copolymer.

According to a preferred embodiment, the adhesive composition of the invention may consist of the following components, expressed in percentage by weight based on the total weight of the composition:

| | |
|---|---|
| acrylate monomer | 9-98 |
| acrylate oligomer | 0-75 |
| photoinitiator | 2-8 |
| co-initiator | 0-12 |
| modifying additive | 0-30 |

Advantageously, as will be seen below with reference to the detailed description in which some application examples are reported, the adhesive composition according to the present invention has proved to be particularly performing for applications in the field of manufacturing multilayer polymeric products comprising an adhesive interface layer, arranged sandwiched between a planar substrate and a covering layer of polymeric material, wherein a layer of digital printing ink, preferably a U.V. ink, is deposited on a surface of said planar substrate to define a printing pattern, successfully solving the technical problem described above.

In particular, as will be seen below, the adhesive composition according to the invention, once cured and solidified, shows an adequate degree of crosslinking, as well as ensures the degree of adhesion required between the different layers of the multilayer polymeric product with which it is in contact.

The above-mentioned technical problem is thus solved by a process for the application of a covering layer to a polymeric product comprising the steps of:
providing a polymeric product in the form of a planar substrate of polymeric material, preferably of a neutral color, for example white, with an ink layer for digital printing, preferably a U.V. ink, deposited on a surface of said planar substrate to define a printing pattern;
   applying, above said ink layer, the adhesive composition according to the present invention, thereby providing an interface layer;
   applying a covering layer of transparent polymeric material, above said interface layer and as a protection of the printing pattern;
being made to polymerize said interface layer by irradiating the covering layer thus applied onto it with ultraviolet radiation.

Preferably, during said polymerization step the ultraviolet radiation has a wavelength generally between 150 nm and 420 nm.

In particular, said polymerization step of the interface layer may be carried out by means of a LED lamp or of a mercury-vapor lamp.

More preferably, said polymerization step of the interface layer may be carried out by means of a LED lamp concentrating the power peak at a specific wavelength, between 278 nm and 405 nm, more preferably between 385 nm and 405 nm.

Specifically, said LED lamp may have a power up to 36 Watts and may be single or multiple windows.

Alternatively, said polymerization step of the interface layer may be carried out by means of a mercury-vapor lamp concentrating the power peak at a specific wavelength, between 150 nm and 420 nm.

Specifically, said mercury lamp may be a medium pressure mercury lamp and have a power up to 240 Watts.

Advantageously, in said polymerization step the interface layer is exposed to an ultraviolet light, which may be achieved continuously at the exit of the covering layer application station.

To be noted that, in the wording used in the present description and claims, the ink layer does not involve necessarily a complete coverage of the planar substrate, areas not affected by the deposit of ink drops being possible.

The application of the interface layer thus avoids a direct contact between the ink and the covering layer. The barrier effect is therefore prevented, which, in the background art processes, prevents satisfactory adhesion of the covering layer on certain inks, preferentially used in digital printing, such as for example U.V. inks, water-borne inks or, sometimes, solvent-borne inks.

Therefore, in an absolutely advantageous way, the process according to the present invention allows to obtain a multilayer polymeric product wherein the interface layer is made with the adhesive composition according to the invention, polymerizable by irradiation with ultraviolet radiation.

Consistently, using the adhesive composition according to the invention, first it is possible to make an interface layer with high affinity with the underlying substrate, the ink layer, as well as the covering layer.

In fact, during such polymerization step, not only the solidification of the adhesive composition, and therefore its complete curing, occurs, but really the curing of the latter generates the perfect adhesion between the thus formed interface layer and the underlying substrate, between the interface layer and the ink layer and between the interface layer and the covering layer.

The multilayer polymeric product made with the process is preferably a polymeric sheet, which may be later used for example to decorate a floor panel.

The polymeric product may be also an already formed thermoplastic panel; in this case, feeding the panel continuously and then carrying out the following steps of the present process is preferable, by rolling it with the covering layer and making to polymerize the interface layer; finally, a cutting step of the thus obtained multilayer panel is provided.

In a preferred embodiment of the present invention, the step of providing the planar substrate comprises a step of digital printing wherein the ink layer is deposited, said digital printing being carried out in line with the subsequent steps of applying the interface layer, applying the covering layer, and carrying out the polymerization of the interface layer.

In other words, the decorated sheet or panel is made with a single equipment, the post-process steps with the application of the covering layer and the polymerization of the interface layer being provided directly at the exit of the digital printer.

Preferably, in the above-mentioned application step of the covering layer of a transparent polymeric material, the covering layer may be made of polyvinyl chloride.

More preferably, said application step of the covering layer of a transparent polymeric material is carried out so that the PVC covering layer has a thickness lower than or equal to 7 mm.

Even more preferably, the PVC covering layer has a thickness between 50 μm and 700 μm.

In a preferred embodiment, the planar substrate and the covering layer are both made of polyvinyl chloride.

On the other hand, it is noted that the two polymeric materials constituting the planar substrate and the covering layer may be also different from PVC; it is further noted that the two substrate and covering materials are not necessarily the same, being provided a PVC substrate and a cover of a different material or vice versa.

Furthermore, there is to say that the planar substrate may be made of a flexible polymeric material, so to make the planar substrate itself, as well as possible coupling products therefrom derived, as a multilayer polymeric product obtainable by the present process, flexible, i.e., adapted to assume a not-flat configuration.

Advantageously, as previously mentioned, the step of applying the covering layer is carried out by rolling. The covering layer is therefore fed continuously and superimposed on the planar substrate through rolling calenders which determine its cohesion.

Preferably, the rolling applying the covering layer is a cold rolling. As previously mentioned, the presence of the intermediate ink layer prevents in any way the coupling of the two softened plastic materials, and the heating is therefore superfluous. The presence of the adhesive of the interface layer instead guarantees the coupling between the layers.

Therefore, with respect to the known technology in which a solvent-borne ink is used and no interface layer obtained by polymerization of an adhesive composition is provided, the technology according to the present invention does not require either a step of evaporation of the printing ink solvent, or a hot rolling step to apply the covering layer, resulting in significant energy savings and a related advantage from the point of view of reduced greenhouse gas emissions.

With respect to the known technology in which a solvent-borne ink is used and no interface layer obtained by polymerization of an adhesive composition is provided, the process according to the present invention can therefore result in a significant advantage from the point of view of its sustainability in both economic and environmental terms, but also in terms of healthiness and safety in the workplace for the involved operators.

Preferably, when the ink layer comprises a U.V. ink, the process may further comprise a step of fixing the ink layer by exposition to ultraviolet light, being said step before the step of applying the interface layer.

In the case of using a different kind of ink, for example a water-borne solvent, a different ink fixing device may be provided in the correspondence of the same station, for example a drying station.

Preferably, the adhesive composition of the interface layer is applied by means of an applicator roller, which can be opposed to a feedback roller. The planar substrate is slid within the two rollers.

More preferably, the planar substrate is slid within the afore-mentioned rollers at a speed between 20 m/min and 60 m/min.

In an equally preferred way, the adhesive composition of the interface layer may be applied according to a grammage between 5 g/m² and 35 g/m².

In an alternative embodiment, the interface layer may be applied directly in the correspondence of the digital printer, for example by a dedicated printing module.

As previously stated, the step of deposing the ink layer, applying the interface layer, applying the covering layer, and polymerizing the interface layer, are carried out in line, i.e., continuously on the planar substrate moving along a direction of advance.

The above outlined technical problem is solved also by a multilayer polymeric product, preferably shaped as a sheet or panel, obtainable by the process according to the invention.

In the essence, the multilayer polymeric product according to the present invention comprises a planar substrate of polymeric material, an ink layer defining a printing pattern directly contacted to a surface of said planar substrate; a covering layer of transparent polymeric material contacted to said ink layer and as a protection of the printing pattern, an interface layer interposed between the ink layer and the covering layer, i.e., in which the interface layer is obtained by polymerizing and curing the adhesive composition according to the present invention.

Preferably, the ink layer comprises a U.V. ink.

Further characteristics and advantages will become more apparent from the detailed description given below of a preferred but not exclusive embodiment of the present invention, with reference to the accompanying figures given by way of non-limiting example, as well as including, as mentioned, some experimental examples.

### BRIEF DESCRIPTION OF THE DRAWINGS

FIG. 1 shows a schematic view, with altered proportions to highlight the aspects of interest, of a polymeric product, in particular a PVC sheet, made according to the background art.

FIG. 2 shows a schematic view, with altered proportions to highlight the aspects of interest, of a polymeric product, in particular a PVC sheet, made according to the present invention.

FIG. 3 illustrates schematically a device to implement the application process of the covering layer according to the present invention.

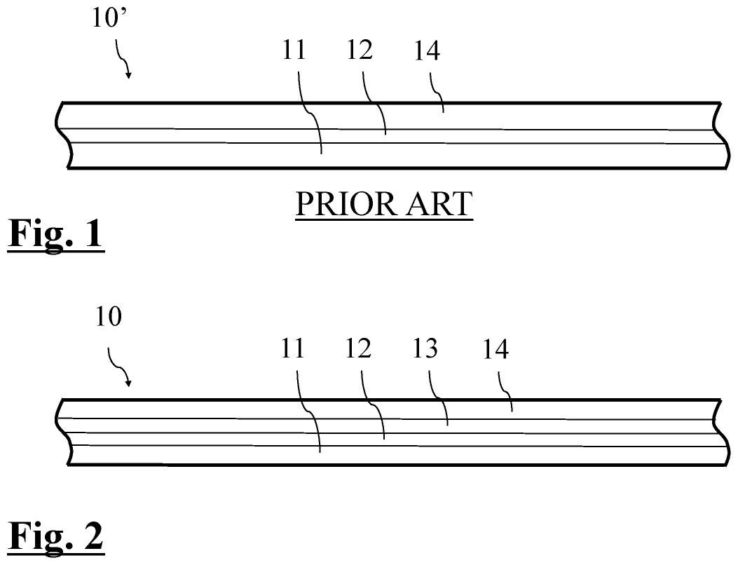

### DETAILED DESCRIPTION

The adhesive composition according to the present invention was used in a process for the application of a covering layer to a polymeric product, as described above in relation to the summary of the invention.

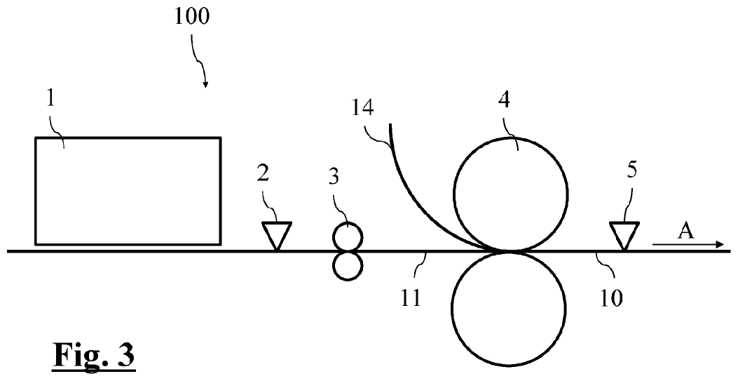

With reference to the attached FIG. 3, the process according to the invention was carried out with the aid of a device, which we identify globally with 100 for the application of a covering layer to a polymeric product 10, in particular a PVC sheet.

In the following description, terms such as above, below, lower, upper, or derivatives thereof are to be understood with reference to the normal configuration of use of the device 100 illustrated in the above figure.

The device 100 provides for advancing means, not shown because known per se, of a PVC planar substrate 11, of neutral coloration (for example white), along the different process stations.

A first process station is represented by a digital printer 1, illustrated schematically in the above-mentioned figure.

The digital printer presents in a known manner one or more printing modules, for example four printing modules relating to the different colors of a four-color printing. Each module comprises one or more print heads designed to release ink drops on the planar substrate 11 that passes under them.

Consistently, a color fixing station 2 is placed at the exit from the digital printer 1 and consists of an ultraviolet light lamp.

A different fixing station 2 may be provided according to the used ink type.

Downstream of the fixing station 2 an application station 3 of the interface layer 13 is provided. Such station consists of an application roller and a counterposed feedback roller, wherein the application roller is fed with the polymerizable adhesive composition according to the invention.

After the application station 3, a rolling station 4 is provided, constituted in a per se known manner by two rolling calenders.

In this station, the process provides for the coupling to a planar substrate 11 of a covering layer 14, fed continuously, to protect the already made printing pattern. The interface layer 13 is therefore placed between planar substrate 11 and covering layer 14, as shown in FIG. 2.

Finally, the device provides for a last polymerization station 5 of the interface layer 13, placed at the exit to the above-mentioned rolling rollers 4.

The polymerization station 5 may be an ultraviolet light lamp. For example, for the polymerization station 5 a LED lamp or a mercury-vapor lamp is used, which can concentrate the peak of power at a specific wavelength, comprised according to the project choices between 150 nm and 420 nm.

In particular, given the partially multi-chromatic nature of the emitted ultraviolet radiation, both the possible LED lamp and the possible mercury-vapor lamp can concentrate a plurality of power peaks at more specific wavelengths.

Specifically, the LED lamp can concentrate a plurality of power peaks at wavelength between 385 nm and 405 nm; vice versa, the mercury-vapor lamp can concentrate a plurality of power peaks at wavelength between 150 nm and 420 nm.

Experimental examples will now follow wherein different adhesive compositions according to the present invention were used in a process for applying a covering layer to a polymeric product to obtain a multilayer polymeric product comprising an interface layer consisting of a solidified polymeric adhesive formed by polymerizing and curing by U.V. irradiation the described adhesive composition.

### Example 1

First, a polymeric product shaped as a planar substrate of polymeric material was provided, more precisely a polyvinyl chloride sheet of white color with a thickness of 70 μm.

The PVC sheet was then sent to the digital printer, within which a digital printing step was carried out.

During the digital printing step, on the upper surface of the PVC sheet a U.V. ink layer for CPUV-type digital printing was applied, supplied by INX International.

Within the color fixing station, with the aid of a 16-watt ultraviolet light LED lamp with double window (40 mm×200 mm), whose peak of power was set at a wavelength of 395 nm, the applied ink layer was then cured, defining a printing pattern.

Then, in the application station, on the ink layer, as well as on the remained free upper surface of the PVC sheet, an adhesive composition layer according to the invention was applied, consisting of the following components, indicated as a percentage by weight of the total weight of the composition:

| | | |
|---|---|---|
| acrylate monomer | 1,6-hexandiol-diacrylate | 94 |
| photoinitiator | Omnirad 819 | 6 |

wherein 1,6-hexandiol-diacrylate is supplied by Allnex, and Omnirad 819 is phenylbis(2,4,6-trimethylbenzoil)phosphine oxide, supplied by IGM Resins.

The PVC sheet was slid on the feedback roller at a speed of 40 m/min, while the application roller was fed with the adhesive composition of the previous paragraph.

The adhesive composition was applied according to a grammage of 12 g/m². Then, on the interface layer a covering layer shaped as a PVC transparent sheet with a thickness of 700 μm was applied, protecting the printing pattern.

Further, in the following rolling station, the planar substrate was coupled to the previously applied covering layer.

Finally, the thus obtained multilayer polymeric product was sent to a polymerization station, i.e., to an ultraviolet light LED lamp, so that the adhesive composition constituting the interface layer was polymerized and cured.

The ultraviolet light LED lamp was set so to concentrate a peak of power at a wavelength of 395 nm; the lamp had a power of 16 watt and was of the double window type (40 mm×200 mm).

### Example 2

In this example a multilayer polymeric panel was obtained carrying out a process comprising all the steps listed in the previous example, but according to the following technical specifications.

The adhesive composition according to the invention consisted of the following components, indicated as a percentage by weight of the total weight of the composition:

| | | |
|---|---|---|
| acrylate monomer | 1,6-hexandiol-diacrylate | 84.6 |
| diluent | Vinnol H 40/43 | 9.4 |
| photoinitiator | Omnirad 819 | 6 |

wherein 1,6-hexandiol-diacrylate is supplied by Allnex, Vinnol H 40/43 is a copolymer with about 66% by weight of vinyl chloride and about 34% by weight of vinyl acetate, supplied by Wacker; Omnirad 819 is phenyl bis(2,4,6-trimethylbenzoil)phosphine oxide, supplied by IGM Resins.

The PVC sheet was slid on the feedback roller at a speed of 30 m/min, while the application roller was fed with the above adhesive composition.

The adhesive composition was applied according to a grammage of 6 g/m². Unless otherwise indicated, all other technical specifications coincided with those referred to in Example 1.

### Example 3

In this example a multilayer polymeric panel was obtained carrying out a process comprising all the steps listed in Example 1, but according to the following technical specifications.

The adhesive composition according to the used invention consisted of the following components, indicated as a percentage by weight of the total weight of the composition:

| | | |
|---|---|---|
| acrylate monomer | 1,6-hexandiol-diacrylate | 65.8 |
| modifying additive | Vinnol H 40/43 | 28.2 |
| photoinitiator | Omnirad 819 | 6 |

wherein 1,6-hexandiol-diacrylate is supplied by Allnex, Vinnol H 40/43 is a copolymer with about 66% by weight of vinyl chloride and about 34% by weight of vinyl acetate, supplied by Wacker; Omnirad 819 is phenyl bis(2,4,6-trimethylbenzoil)phosphine oxide, supplied by IGM Resins.

The PVC sheet was slid on the feedback roller at a speed of 50 m/min, while the application roller was fed with the above adhesive composition.

The adhesive composition was applied according to a grammage of 6 g/m².

Unless otherwise indicated, all other technical specifications coincided with those referred to in Example 1.

### Example 4

In this example a multilayer polymeric panel was obtained carrying out a process comprising all the steps listed in Example 1, but according to the following technical specifications.

The adhesive composition according to the used invention consisted of the following components, indicated as a percentage by weight of the total weight of the composition:

| | | |
|---|---|---|
| acrylate monomer | 1,6-hexandiol-diacrylate | 54 |
| acrylate oligomer | Ebecryl 85 | 36 |
| co-initiator | Ebecryl P116 | 5 |
| photoinitiator | Omnirad 819 | 5 |

wherein 1,6-hexandiol-diacrylate is supplied by Allnex, Ebecryl 85 is an amine modified polyether acrylate supplied by Allnex; Ebecryl P116 is a tertiary amine supplied by Allnex and Omnirad 819 is phenyl bis(2,4,6-trimethylbenzoil)phosphine oxide, supplied by IGM Resins.

The PVC sheet was slid on the feedback roller at a speed of 50 m/min, while the application roller was fed with the above adhesive composition.

The adhesive composition was applied according to a grammage of 12 g/m².

Unless otherwise indicated, all other technical specifications coincided with those referred to in Example 1.

### Example 5

In this example a multilayer polymeric panel was obtained carrying out a process comprising all the steps listed in Example 1, but according to the following technical specifications.

The adhesive composition according to the used invention consisted of the following components, indicated as a percentage by weight of the total weight of the composition:

| | | |
|---|---|---|
| acrylate monomer | 1,6-hexandiol-diacrylate | 54 |
| acrylate oligomer | Ebecryl 820 | 36 |
| co-initiator | Ebecryl P116 | 5 |
| photoinitiator | Omnirad 819 | 5 |

wherein 1,6-hexandiol-diacrylate is supplied by Allnex, Ebecryl 820 is a polyester acrylate supplied by Allnex; Ebecryl P116 is a tertiary amine supplied by Allnex and Omnirad 819 is phenyl bis(2,4,6-trimethylbenzoil)phosphine oxide, supplied by IGM Resins.

The PVC sheet was slid on the feedback roller at a speed of 40 m/min, while the application roller was fed with the above adhesive composition.

The adhesive composition was applied according to a grammage of 24 g/m².

Unless otherwise indicated, all other technical specifications coincided with those referred to in Example 1.

### Example 6

In this example a multilayer polymeric panel was obtained carrying out a process comprising all the steps listed in Example 1, but according to the following technical specifications.

The adhesive composition according to the used invention consisted of the following components, indicated as a percentage by weight of the total weight of the composition:

| | | |
|---|---|---|
| acrylate monomer | 1,6-hexandiol-diacrylate | 54 |
| acrylate oligomer | Ebecryl 605 | 36 |
| co-initiator | Ebecryl P116 | 5 |
| photoinitiator | Omnirad 819 | 5 |

wherein 1,6-hexandiol-diacrylate is supplied by Allnex, Ebecryl 605 is bisphenol A epoxy diacrylate supplied by Allnex; Ebecryl P116 is a tertiary amine supplied by Allnex and Omnirad 819 is phenyl bis(2,4,6-trimethylbenzoil)phosphine oxide, supplied by IGM Resins.

The PVC sheet was slid on the feedback roller at a speed of 40 m/min, while the application roller was fed with the above adhesive composition.

The adhesive composition was applied according to a grammage of 24 g/m².

Unless otherwise indicated, all other technical specifications coincided with those referred to in Example 1.

### Example 7

In this example a multilayer polymeric panel was obtained carrying out a process comprising all the steps listed in Example 1, but according to the following technical specifications.

The adhesive composition according to the used invention consisted of the following components, indicated as a percentage by weight of the total weight of the composition:

| | | |
|---|---|---|
| acrylate monomer | 1,6-hexandiol-diacrylate | 56 |
| acrylate oligomer | Ebecryl 85 | 38 |
| photoinitiator | ITX | 6 |

wherein 1,6-hexandiol-diacrylate is supplied by Allnex, Ebecryl 85 is an amine modified polyether acrylate supplied by Allnex; ITX is 2-isopropylthioxanthone supplied by Lambson.

The PVC sheet was slid on the feedback roller at a speed of 20 m/min, while the application roller was fed with the above adhesive composition.

The adhesive composition was applied according to a grammage of 12 g/m².

Unless otherwise indicated, all other technical specifications coincided with those referred to in Example 1.

### Example 8

In this example a multilayer polymeric panel was obtained carrying out a process comprising all the steps listed in Example 1, but according to the following technical specifications.

The adhesive composition according to the used invention consisted of the following components, indicated as a percentage by weight of the total weight of the composition:

| | | |
|---|---|---|
| acrylate monomer | 3-methyl pentanediyl diacrylate | 54 |
| acrylate oligomer | Ebecryl 85 | 36 |
| co-initiator | Ebecryl P116 | 5 |
| photoinitiator | Omnirad 819 | 5 |

wherein 3-methyl pentanediyl diacrylate is supplied by Arkema Sartomer; Ebecryl 85 is an amine modified polyether acrylate supplied by Allnex; Ebecryl P116 is a tertiary amine supplied by Allnex and Omnirad 819 is phenyl bis(2,4,6-trimethylbenzoil)phosphine oxide, supplied by IGM Resins.

The PVC sheet was slid on the feedback roller at a speed of 40 m/min, while the application roller was fed with the above adhesive composition.

The adhesive composition was applied according to a grammage of 32 g/m².

Unless otherwise indicated, all other technical specifications coincided with those referred to in Example 1.

Adhesion Tests

For each of the multilayer polymeric products obtained in the previous Examples 1-8, adhesion tests were performed.

First, each of the multilayer polymeric products obtained in the previous Examples 1-8 was subjected to an embossing process, during which in a first time the various rolled products were place in an oven at 160° C. for 5 min.

Then, in a conventional way, different foldings were made on each led to temperature rolled product, so to simulate final application; further, the rolled products were cooled at room temperature.

Once room temperature was reached, the thus folded rolled products were subjected to peeling tests.

The peeling test was manually performed: the operation was carried out by taking the flap of each of the outermost layers that made up the laminate and pulling the flaps with a traction movement opposite to each other, until at least one of the flaps was broken.

Following the peeling test, the multilayer product could present itself in a substantially unaltered form at the level of coupling between the different layers that made it up, i.e., it did not delaminate, or in a partial or total delamination conformation.

The outcome of the performed embossing tests is summarized in the following Table 1.

TABLE 1

| Sample | Rolling |
|---|---|
| Ex. 1 | It does not delaminate |
| Ex. 2 | It does not delaminate |
| Ex. 3 | It does not delaminate |
| Ex. 4 | It does not delaminate |
| Ex. 5 | It does not delaminate |
| Ex. 6 | It does not delaminate |
| Ex. 7 | It does not delaminate |
| Ex. 8 | It does not delaminate |

So, advantageously, it was proven that the multilayer polymeric products obtained by the afore-mentioned process and using the adhesive composition according to the invention for the realization of an interface layer between a planar polymeric substrate and a covering layer showed optimal properties from the adhesion point of view between the different layers that made them up.

1. An adhesive composition polymerizable by applying ultraviolet radiation comprising an acrylate resin and a photoinitiator, said acrylate resin comprising at least one acrylate monomer, wherein said at least one acrylate monomer is selected from an alkyl acrylate, an alkyl methacrylate, a diol diacrylate, a diol dimethacrylate, a polyol diacrylate, a polyol dimethacrylate, a polyol triacrylate, a polyol dimethacrylate, a polyol trimethacrylate, or any combination thereof.

2. The adhesive composition according to claim 1, wherein said at least one acrylate monomer is a diol diacrylate, preferably said acrylate monomer being 1,6-hexanediol diacrylate, 3-methyl-1,5-pentanediyl acrylate, or any combination thereof.

3. The adhesive composition according to claim 1, wherein said photoinitiator is a Norrish type I photoinitiator or a Norrish type II photoinitiator.

4. The adhesive composition according to claim 3, wherein said photoinitiator is a compound belonging to the family of acyl phosphines, preferably said photoinitiator being selected from phenylbis(2,4,6-trimethylbenzoyl)phosphine oxide, diphenyl(2,4,6-trimethylbenzoyl)phosphine oxide or any combination thereof, more preferably said photoinitiator being phenylbis(2,4,6-trimethylbenzoyl)phosphine oxide.

5. The adhesive composition according to claim 3, wherein said photoinitiator is a compound belonging to the family of thioxanthones, preferably said photoinitiator is selected from 4-isopropylthioxanthone, 2-isopropylthioxanthone or any combination thereof, more preferably said photoinitiator is 2-isopropylthioxanthone.

6. The adhesive composition according to claim 1, wherein said photoinitiator is present in an amount between 2% and 8%, preferably between 3% and 6%, by weight based on the total weight of the adhesive composition.

7. The adhesive composition according to claim 1, wherein said at least one acrylate monomer is present in an amount between 9% and 98%, preferably between 15% and 97%, more preferably between 20% and 80%, by weight based on the total weight of the adhesive composition.

8. The adhesive composition according to claim 1, wherein said acrylate resin comprises at least one acrylate oligomer, preferably said at least one acrylate oligomer being selected from polyurethane acrylate, epoxy acrylate, acryl acrylate, polyether acrylate, polyester acrylate, vinyl acrylate or any combination thereof.

9. The adhesive composition according to claim 8, wherein said at least one acrylate oligomer is present an amount between 1% and 88.5%, preferably between 15% and 75%, more preferably between 40% and 60%, by weight based on the total weight of the adhesive composition.

10. The adhesive composition according to claim 1, wherein said adhesive composition comprises at least one co-initiator, preferably said co-initiator being a tertiary amine, more preferably a tertiary alkylamine, and/or said adhesive composition comprises at least one modifying additive, preferably one organic modifying additive, more preferably said modifying additive being a vinyl copolymer.

11. The adhesive composition according to claim 1, wherein said composition consists of the following components, expressed in percentage by weight based on the total weight of the composition:

| | |
|---|---|
| acrylate monomer | 9-98 |
| acrylate oligomer | 0-75 |
| photoinitiator | 2-8 |
| co-initiator | 0-12 |
| modifying additive | 0-30 |

12. A process for the application of a covering layer to a polymeric product comprising the steps of:
providing a polymeric product in the form of a planar substrate of polymeric material with an ink layer for digital printing, preferably a U.V. ink, deposited on a surface of said planar substrate to define a printing pattern;
applying, above said ink layer, the adhesive composition according to claim 1, thereby providing an interface layer;
applying a covering layer of transparent polymeric material above said interface layer and as a protection of the printing pattern;
being made to polymerize said interface layer by irradiating the covering layer so applied onto it with ultraviolet radiation,
preferably said ultraviolet radiation having a wavelength between 150 nm and 420 nm.

13. The process for the application of a covering layer to a polymeric product according to claim 12, wherein said polymerization step said interface layer is carried out by means of a LED lamp or of a mercury-vapor lamp, preferably said mercury-vapor lamp concentrating a peak of power at a specific wavelength between 150 nm and 420 nm or said LED lamp concentrating a peak of power at a specific wavelength between 385 nm and 405 nm.

14. The process for the application of a covering layer to a polymeric product according to claim 12, wherein in said step of applying a covering layer of transparent polymeric material said covering layer is made of polyvinyl chloride, preferably said covering layer having a thickness lower than or equal to 7 mm.

15. A multilayer polymeric product, preferably in the form of a sheet or a panel, obtainable by the process according to claim 12.
